(19) United States
(12) Patent Application Publication
(10) Pub. No.: US 2026/0213515 A1
(43) Pub. Date: Jul. 23, 2026

(54) Aerial Support Tie Spacer

(71) Applicant: HellermannTyton Corporation, Milwaukee, WI (US)

(72) Inventors: Scott G. Klos, Grafton, WI (US); Mark W. Cors, St Francis, WI (US); Jonathan Zick, Waukesha, WI (US); Ron Kovac, Colgate, WI (US); Greg Gency, Crofton, MD (US); Jerad Grewe, Waukesha, WI (US)

(73) Assignee: HellermannTyton Corporation, Milwaukee, WI (US)

(21) Appl. No.: 19/290,619

(22) Filed: Aug. 5, 2025

Related U.S. Application Data
(60) Provisional application No. 63/746,584, filed on Jan. 17, 2025.

(51) Int. Cl. H02G 7/12

(52) U.S. Cl. CPC H02G 7/12

(57) ABSTRACT

Disclosed are aerial support tie spacers configured to space a first object apart from a second object. The spacer includes first and second stacking connectors on opposing top and bottom sides. The spacer includes a strap passageway defined in a first side that extends from the top side to the bottom side. The strap passageway is configured to receive an elongated strap therethrough in a first direction. The spacer includes an open channel defined in a second side that extends from the top side to the bottom side, the second side opposite the first side. The open channel is configured to receive the elongated strap therein in a second direction that is opposite the first direction.

### INCORPORATION BY REFERENCE

This application claims the benefit of U.S. Provisional Application No. 63/746,584, filed Jan. 17, 2025, the disclosure of which is incorporated herein by reference.

### BACKGROUND

An electrical power supply system may distribute power through a pole-mounted, overhead distribution line. In conjunction therewith or separately therefrom, a communication system (e.g., a telecommunications system) may distribute communication signals through pole-mounted communication cables. The communication cables may be routed through junction boxes that come in a variety of forms and cable counts, which may be connected and/or split within the junction boxes to meet the specifications of the signal provider.

Overhead distribution lines and communication systems may utilize a spacer cable system that includes at least one covered conductor (e.g., an insulated conductor). In a spacer cable system, one or more of the covered conductors may be bundled together and suspended from a non-conducting messenger cable (e.g., a guide wire) that extends between the poles. The covered conductors may be bundled together via an aerial cable tie (e.g., an aerial support tie, a lashed cable support) that includes a head and an elongated strap. In some cases, the aerial cable tie is a one-piece tie where the head and the elongated strap are integral to one another; whereas in other cases, the cable tie head is provided separately from the elongated strap. The aerial cable tie can be utilized to connect a communications cable directly to the messenger cable for routing along distances.

A cable spacer (e.g., aerial cable spacer) may be used to space the covered conductors apart in the bundle to maintain consistent separation between the bundled covered conductors. The cable spacer may be integral to the head of the cable tie, for example, in the lashing support spacer ties that are described and illustrated in the published application US 2016/0091122 A1, filed Sep. 29, 2015, published Mar. 31, 2016, assigned to HellermannTyton Corporation, the disclosure of which is incorporated herein by reference.

In some cases, a cable spacer may be stacked together with other cable spacers to provide a desired separation distance between the bundles and/or to position a covered conductor within the system. A cable spacer may receive a cable tie therethrough to fix the position of the cable spacer in the bundle.

One disadvantage to traditional cable spacers in spacer cable systems is a complicated assembly installation on-site, which may take place in a telescoping boom bucket aerial lift truck. In such applications, multiple components must be threaded together with a cable tie surrounding two loosely spaced heavy cables, while holding the cable spacers against and in alignment with the cables. The cable tie is then tightened to compress the bundle while maintaining the alignment of the separate cable spacers and cable tie. In addition, installers are required to purchase and maintain an inventory of stackable saddle spacers and cable ties, and have available each component, for assembly, in the boom bucket of the aerial lift truck. As a result, there is a continuing need for improvements to spacer cable systems that overcome the drawbacks of prior solutions.

### SUMMARY

This document describes aerial support tie spacers and aerial support tie systems. The aerial support tie spacers and aerial support tie systems may be utilized within a spacer cable system. This document also describes techniques for manufacturing and techniques for using aerial support tie spacers and aerial support tie systems.

One general aspect includes an aerial support tie spacer that is configured to space a first object (e.g., a covered conductor) apart from a second object (e.g., a non-conducting messenger cable). The spacer includes a first stacking connector on the top side and a second stacking connector on the bottom side. The first stacking connector is configured to engage a second spacer, and the second stacking connector is configured to engage a third spacer. The spacer includes a strap passageway defined in the first side, which extends from the top side to the bottom side. The strap passageway is configured to receive an elongated strap therethrough in a first direction. The spacer also includes an open channel defined in a second side, which extends from the top side to the bottom side. The second side is opposite the first side. The open channel configured to receive the elongated strap therein in a second direction, which is opposite the first direction.

Another general aspect includes an aerial support tie system that is configured to secure the first object (e.g., a covered conductor) and a second object (e.g., a non-conducting messenger cable). The system includes a first spacer configured to space the first object apart from the second object. The spacer includes a first stacking connector on the top side of the spacer and a second stacking connector on an opposite, bottom side. The first stacking connector is configured to engage a stacking connector of a second spacer, and the second stacking connector is configured to engage a stacking connector of a third spacer. The system includes a strap passageway defined in the first side of the spacer, which extends from the top side to the bottom side. The strap passageway is configured to receive an elongated strap of a cable tie w in a first direction. The system includes an open channel defined in an opposite, second side of the spacer. The open channel extends from the top side to the bottom side. The open channel is configured to receive the elongated strap therein in a second direction that is opposite the first direction. The system further includes a second spacer the includes the elongated strap, a head connectable to the elongated strap to form a loop, and a third stacking connector that is configured to engage the second stacking connector.

This Summary is provided to introduce simplified concepts of aerial support tie spacers and aerial support tie systems, which are further described below in the Detailed Description and are illustrated in the Drawings. This Summary is not intended to identify all implementations of the aerial support tie spacers and aerial support tie systems described in the Detailed Description and illustrated in the Drawings and is not intended to identify essential features of the claimed subject matter. Further, this Summary is not intended for use in determining the scope of the claimed subject matter.

### BRIEF DESCRIPTION OF THE DRAWINGS

The details of one or more implementations of aerial support tie spacers and aerial support tie systems are described with reference to the following Drawings.

FIG. 1 is a schematic representation of an aerial support tie spacer.

FIG. 2A is a top perspective view of an aerial support tie spacer from the first side.

FIG. 2B is a top perspective view of the aerial support tie spacer of FIG. 2A from the second side.

FIG. 2C is a bottom perspective view of the aerial support tie spacer of FIG. 2A from the first side.

FIG. 2D is a first side view of the aerial support tie spacer of FIG. 2A.

FIG. 2E is a second side view of the aerial support tie spacer of FIG. 2A.

FIG. 2F is an end view of the aerial support tie spacer of FIG. 2A, the opposite end view substantially a mirror image thereof.

FIG. 3A is a perspective view of an aerial support tie spacer system with a cable tie strap passing through the aligned strap passageways in the three stacked spacers.

FIG. 3B is a perspective view of the aerial support tie spacer system of FIG. 4A, with the cable tie strap passing through the aligned open channels in the three stacked spacers and back though the cable tie head.

FIG. 3C is a cross-sectional view of the aerial support tie spacer system of FIG. 3A along lines 3C-3C in FIG. 4B.

FIG. 3D is a partial, cross-sectional of the aerial support tie spacer system of FIG. 3A along lines 3D-3D in FIG. 3B with an enlargement view.

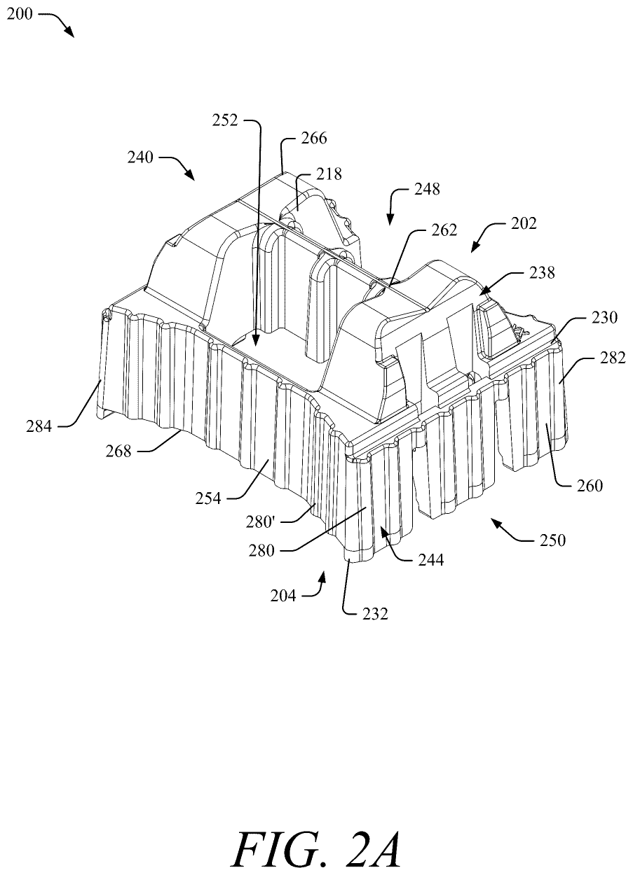

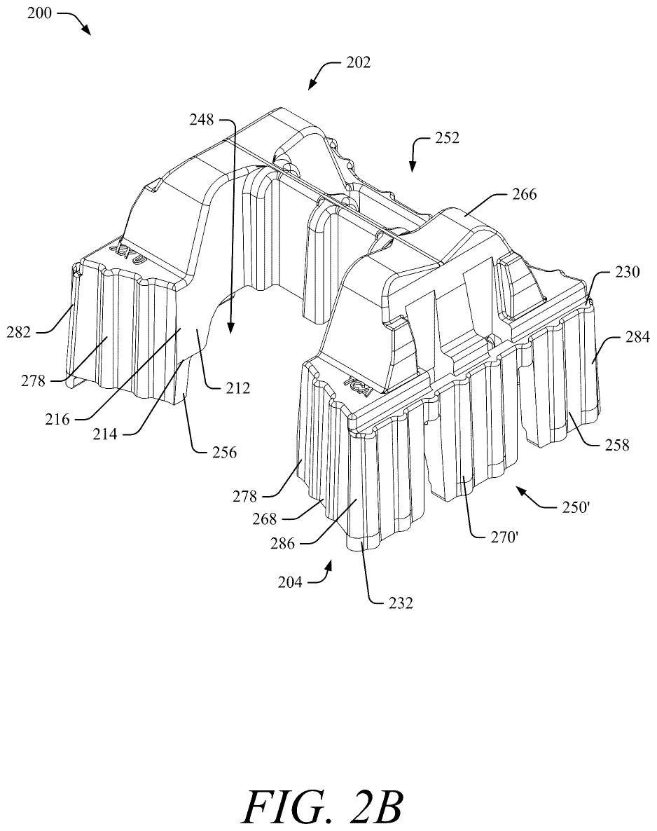

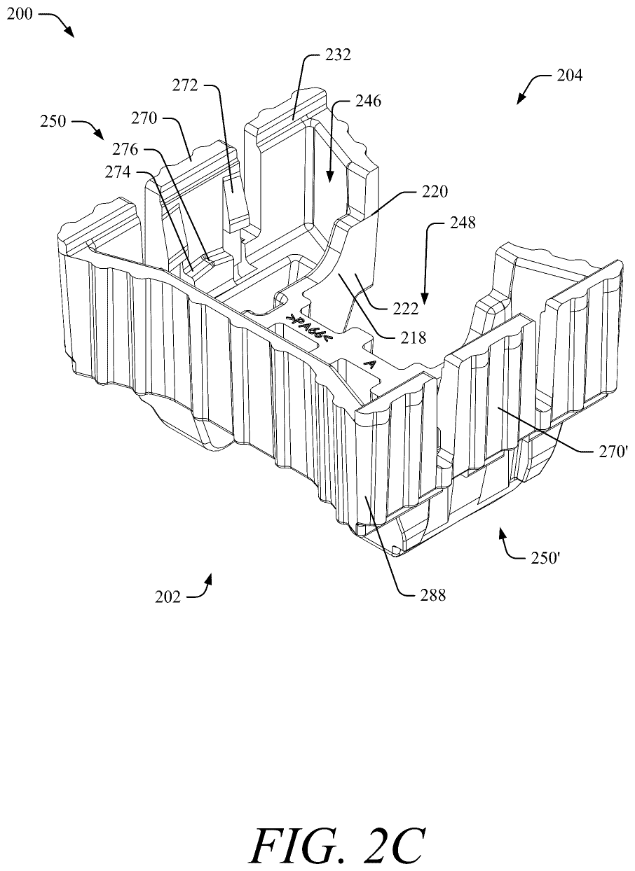

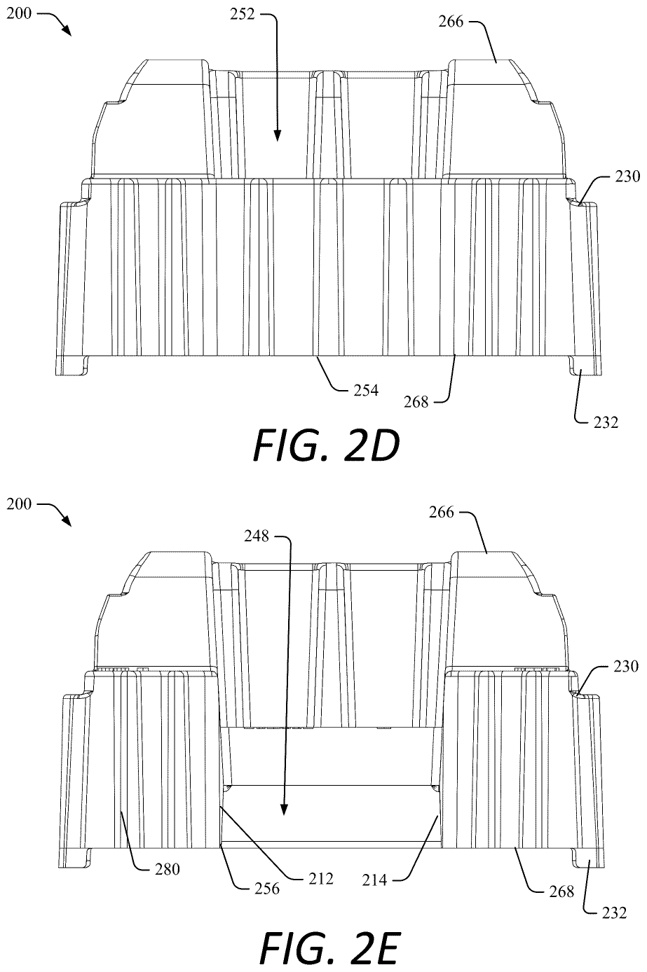

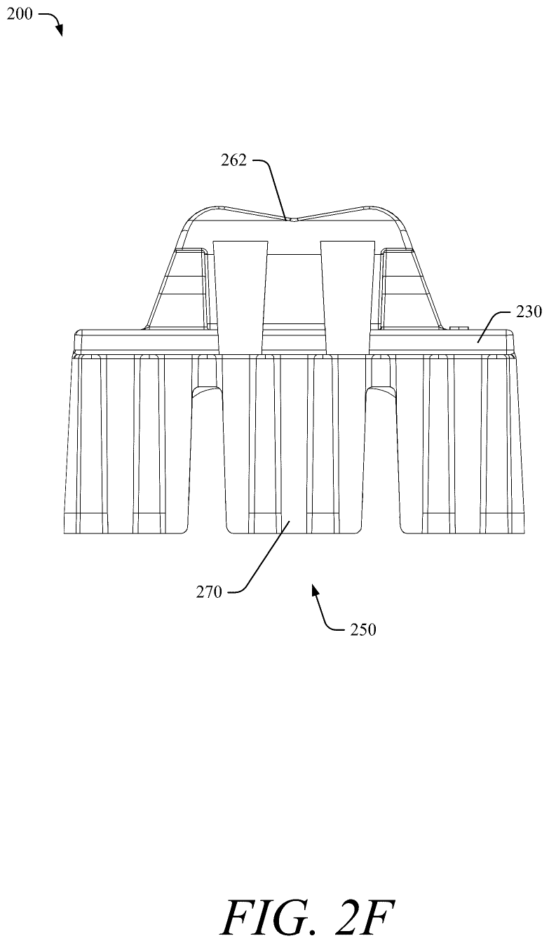

In the Detailed Description, the first digit(s) of a reference character (e.g., call out number) may correlate with the first figure number in which the reference character is labeled. For example, reference characters that start with a 2 (e.g., open channel 248, strap passageway 252) may represent details first called out with respect to FIG. 2. Further, the same reference characters in different Drawings may identify the same or similar features, elements, and/or parts.

### DETAILED DESCRIPTION

This document describes aerial support tie spacers and aerial support tie systems. This document also describes techniques for manufacturing and techniques for using aerial support tie spacers and aerial support tie systems.

The aerial support tie spacers (“spacers”) are configured for use with an aerial support tie in an aerial support tie system, which may be utilized within a spacer cable system. In a general aspect, the spacer is configured to space a first object (e.g., a covered conductor, a guide wire) apart from a second object (e.g., a non-conducting messenger cable, a supported cable). The spacer may be used to provide a stable bridge between the first object and the second object in an installation that has a gap exceeding the height of the aerial support tie in its base configuration.

The spacer includes a first stacking connector on the top side and a second stacking connector on the bottom side. The first stacking connector is configured to engage a second spacer, and the second stacking connector is configured to engage a third spacer. In aspects, the second spacer is the top side of the locking head of an aerial support tie.

The spacer includes a strap passageway defined in the first side, which extends from the top side to the bottom side. The strap passageway is configured to receive an elongated strap therethrough in a first direction. The strap passageway is configured to receive the strap of an aerial support tie therethrough. The strap can be laced through the strap passageway to help align the spacer to the top of the aerial support tie. The spacer also includes an open channel defined in a second side opposite the first side. The open channel extends from the top side to the bottom side. The open channel configured to receive the elongated strap therein in a second direction, which is opposite the first direction. The open channel provides for the easy wrapping of the strap of an aerial support tie around the second object (e.g., guide wire) and back into the top of the aerial support tie. With the strap passageway on the first side and the open channel on the second side, the spacer may be asymmetrical.

The aerial support tie systems include at least one aerial support tie spacer (e.g., as described in the preceding paragraphs) and at least one aerial support tie. An aerial support tie includes a locking head and an elongated strap portion that extends from the locking head. The locking head may be integral to the strap portion. The strap portion is configured for insertion through the locking head to form a loop. The locking head may include a serration-engaging locking pawl mechanism that is configured for engaging strap serrations defined on the strap portion, thereby retaining the strap portion relative to the locking head. The locking head is configured for stacking engagement with at least one spacer that includes a strap passageway opposite an open channel. The strap portion is configured for looping engagement of a first object (e.g., a covered conductor), insertion through the strap passageway of the spacer, looping engagement of a second object (e.g., a non-conducting messenger cable), insertion through the open channel of the spacer, and into engagement with the serration-engaging locking pawl mechanism of the locking head. In this way, the spacer and aerial support tie bundle the first object suspended and spaced apart from the second object. In further aspects, additional spacers may be stacked together with aligned strap passageways and open channels to further space the first object from the second object.

The aspects described herein address technical problems associated with aerial support tie spacers and/or aerial support tie systems in spacer cable systems. The disclosed aerial support tie spacers and aerial support tie systems result in a simpler installation and routing of objects (e.g., electrical cables) in spacer cable systems. The disclosed aerial support tie spacers and aerial support tie systems also facilitate secure holding and retaining of the conductors in spacer cable systems during installation procedures and during use.

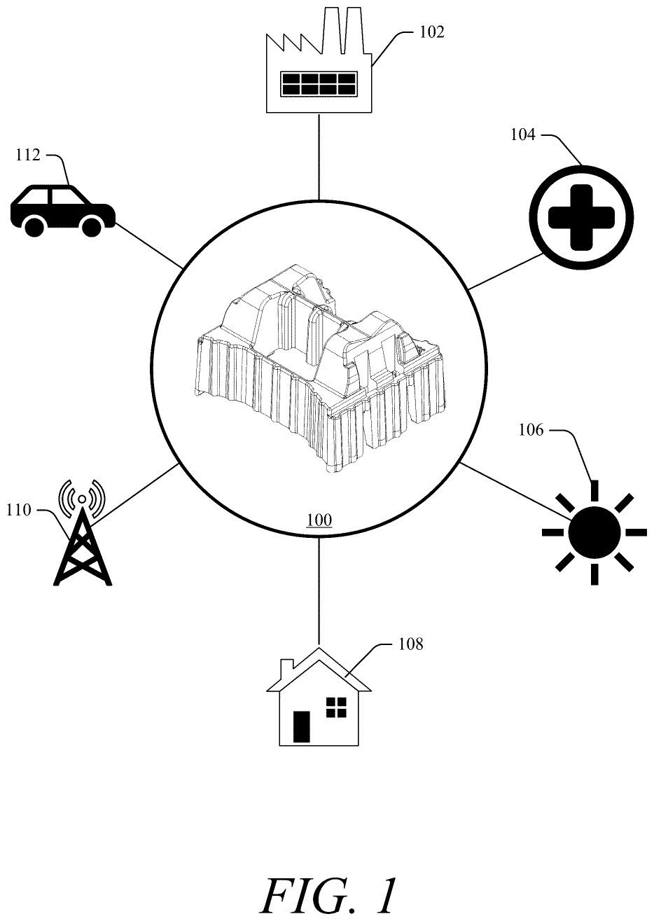

FIG. 1 is a schematic representation of an aerial support tie spacer 100. As discussed herein, the aerial support tie spacer 100 may have particular application in the energy and utility markets 106. While this Detailed Description, including the Drawings, references these markets, an aerial support tie spacer 100 may have application to support cables and other elongated objects in other markets, including but not limited to industrial and manufacturing markets 102, healthcare markets 104, consumer and commercial markets 108, and/or telecommunications and data infrastructure markets 110.

The industrial and manufacturing markets 102 include industrial automation and equipment, control panels, machine building, machinery, electrical enclosures, material handling systems (e.g., conveyors), cooling systems, heavy equipment (e.g., construction and mining machinery), agricultural technology (e.g., farming equipment), chemical (e.g., chemical processing equipment), robotics (e.g., automated robotic systems), original equipment manufacturers (OEMS), mechanical components, and mechanical systems. The healthcare markets 104 include medical equipment and technology, and dental equipment and technology. The energy and utility markets 106 include renewable energy systems (e.g., solar panels, solar arrays, wind turbines, hydroelectric generators), power generation and distribution, industrial lighting, and commercial lighting. The energy and utility markets 106 also include photovoltaic systems that include one or more panels (e.g., solar panels) of photovoltaic cells mounted on a support structure where the electrical output of the solar panels is transferred to the electrical grid or an electrical storage device (e.g., battery) through one or more electrical cables (photovoltaic cables). The consumer and commercial markets 108 include appliances (e.g., home and commercial appliances), heating, ventilation, and air conditioning (HVAC), and consumer electronic devices. The telecommunications and data infrastructure markets 110 include telecommunications (e.g., general telecom services), communications (e.g., communication systems and equipment), internet service providers (ISPs), cable television companies (CATV), infrastructure for data storage and processing (e.g., data centers), broadband (e.g., broadband internet services), and datacom (e.g., data communications equipment). The transportation markets 112 include manufacturing and components for vehicles, trucks, automobiles, rail conveyances (e.g., trains), marine craft (e.g., ships, boats), aircraft, and aerospace.

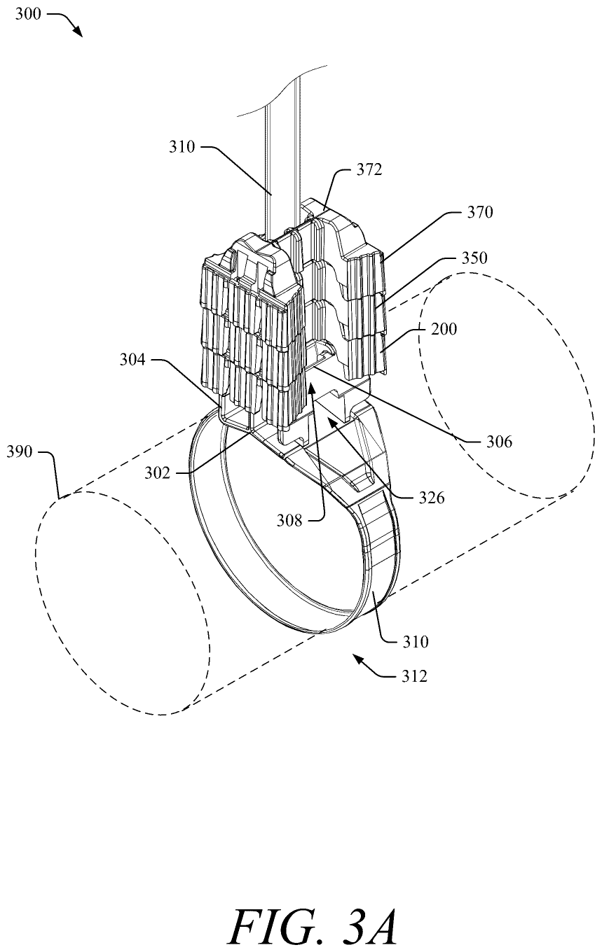

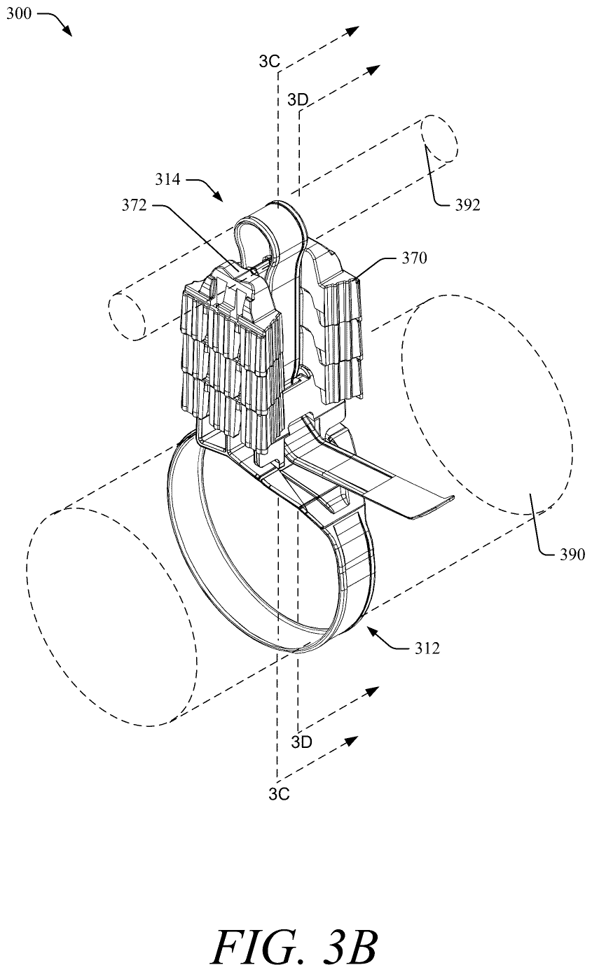

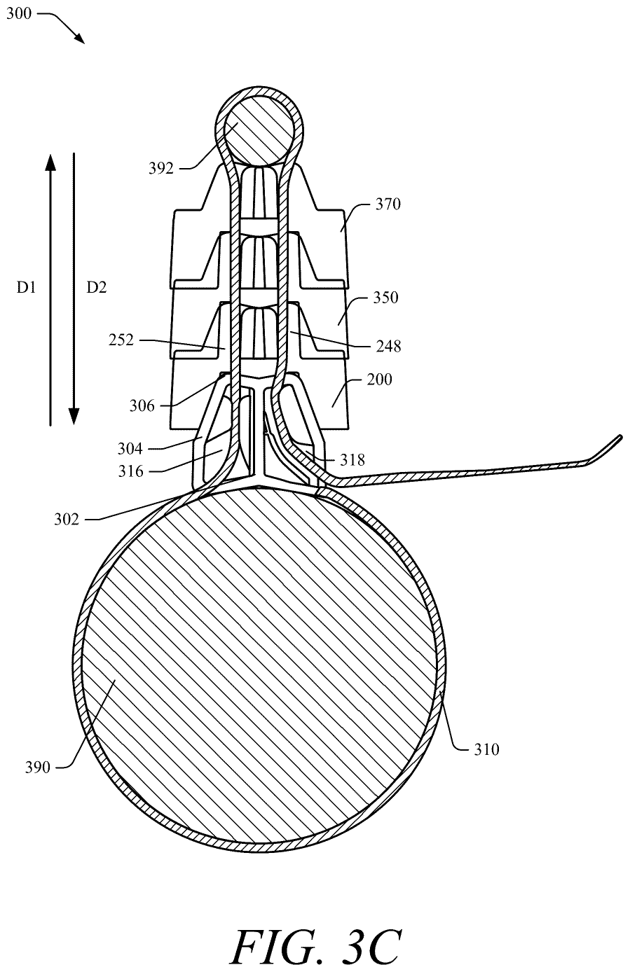

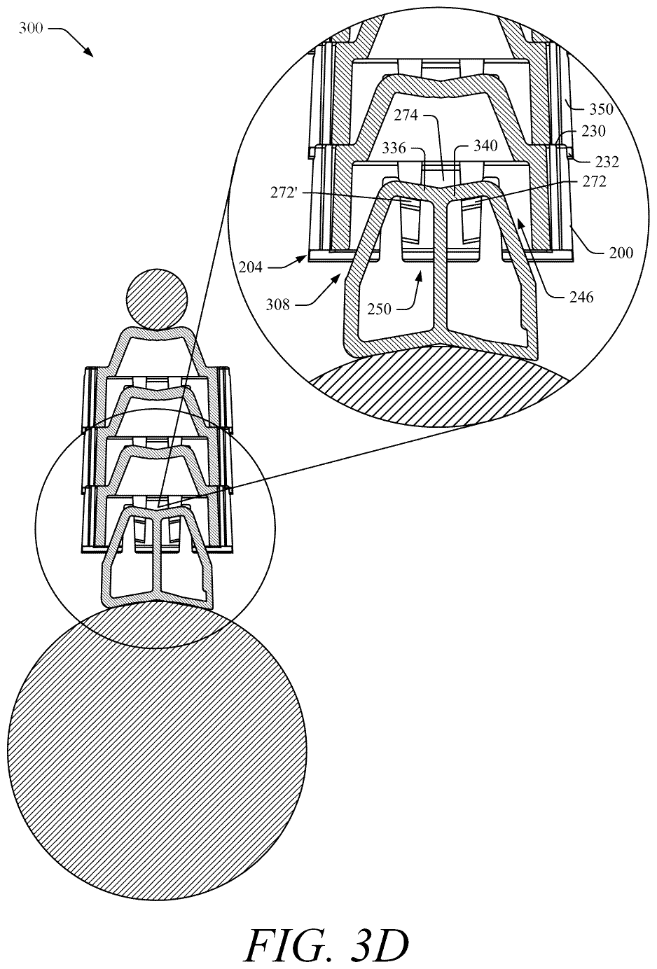

FIGS. 2A-2F illustrate an example aerial support tie spacer 200 (spacer 200). The spacer 200 is similar to the aerial support tie spacer 100 illustrated in FIG. 1 and described above, except as detailed below. The spacer 200 is configured for use with an aerial support tie in an aerial support tie system, examples of which are illustrated in FIGS. 3A-3D. The spacer 200 is configured to space a first object (e.g., first object 390 in FIG. 3A) apart from a second object (e.g., second object 392 in FIG. 3A).

The spacer 200 includes a first stacking connector 202 on the top side 266 of the spacer and a second stacking connector 204 on the bottom 268 of the spacer. The first stacking connector 202 is configured to engage a second spacer and the second stacking connector 204 is configured to engage a third spacer in an aerial support tie system (e.g., system 300 illustrated in FIGS. 3A-3D).

The spacer 200 includes a strap passageway 252 defined in the first side 254. The strap passageway 252 extends from the top side 266 to the bottom side 268 and is configured to receive an elongated strap 310 (e.g., of an aerial support tie 302) therethrough in a first direction D1 (illustrated in FIG. 3C). The spacer 200 also includes an open channel 248 defined on the second side 256, which is opposite the first side 266. The open channel 248 extends from the top side 266 to the bottom side 268. The open channel 248 is configured to receive the elongated strap 310 therein (e.g., the elongated strap of an aerial support tie 302) in a second direction D2 (illustrated in FIG. 3C), which is opposite the first direction D1. In aspects, the open channel 248 includes a first sidewall 212 opposite and spaced apart from a second sidewall 218. The first and second sidewalls are configured to guide the elongated strap 310 in the second direction D2. In aspects, the first and second sidewalls are oriented substantially parallel to one another and, in aspects, the first and second sidewalls are substantially parallel to the second direction D2. It is understood that, unless specified otherwise, the term “substantially parallel,” as used herein, refers to an angle of less than about 45°. In some aspects, “substantially parallel” is less than about 30°, is less than about 15°, is less than about 10°, is less than about 5°, is less than about 4°, is less than about 3°, is less than about 2°, or is less than about 1°.

An outer end of at least one of the first sidewall 212 or the second sidewall 218 may include a projection that extends into the open channel 248, which is configured to retain the elongated strap 310 within the open channel 248. In the aspect illustrated in FIGS. 2A-2E, the outer end 216 of the first sidewall 212 includes a projection 214 that extends into the open channel 248 and the outer end 222 of the second sidewall 218 includes a projection 220 that extends into the open channel 248. In aspects, the projections may extend inwards from the respective side (e.g., first side 254, second side 256) at an angle, for example an angle of less than about 30°, less than about 15°, less than about 10°, less than about 5°, less than about 4°, less than about 3°, less than about 2°, or less than about 1°. In the aspect illustrated in FIGS. 2A-2F, the projections (e.g., projection 214, projection 220) slope upwards and downwards about 3° to define the projection. In other aspects, a projection may be omitted.

The spacer 200 includes an interlock portion that is configured to lock the second stacking connector 204 to a stacking connector of another spacer when they are in a stacked position. The lock may be releasable. Suitable engagements include, but are not limited to, friction fits, interference fits, mechanical connections (e.g., snap fits), and the like. In a first example, the first end 258 includes a first interlock portion 250 (illustrated in FIG. 2B) and the second end 260 includes a second interlock portion 250′ (illustrated in FIG. 2C), which are configured to lock the second stacking connector 204 to a stacking connector of another spacer via a snap fit. The interlock portions (interlock 250, interlock 250') are configured to lock the first spacer 200 to the stacking connector 308 of an aerial support tie 302, as illustrated in FIG. 3D and described below. The interlock portion may include a flexible locking tab (locking tab 270, locking tab 270′) defined in at least one end (e.g., first end 258, second end 260) of the spacer 200. The locking tab is configured to lock the second stacking connector 204 to a stacking connector of another spacer. For example, the locking tab may be configured to lock the second stacking connector 204 to the stacking connector 308 of an aerial support tie 302. The locking tab may include at least one cantilever lug 272 that is configured for snap-fit connection with a connecting ledge (connecting ledge 336, connecting ledge 340) of the second spacer 302, as illustrated in FIG. 3D. In FIG. 3D, the elongated strap 310 is not illustrated, for clarity.

In a second example, the interlock portions (interlock 250, interlock 250′) are configured to lock to a first stacking connector of another spacer via an interference fit, as illustrated in FIG. 3D. The second stacking connector 204 may include a recess 246 that is configured to receive a portion of the second spacer 302 (e.g., a portion of the head 304 of the second spacer 302, as illustrated in FIG. 3D). The spacer 200 may be attachable to the second spacer 302 (e.g., to the head 304 of the second spacer 302) by at least one of an interference fit or a snap fit. The spacer 200 may be attachable to another spacer (e.g., spacer 350, spacer 370) by at least one of an interference fit or a snap fit. For example, the base portion 244 may define a step 230 that is configured to receive a base flange 232 in an interference fit relationship. The step 230 and the baser flange 232 may be formed of flexible materials. In the aspect of FIG. 2A-2F, the base portion 244 and the saddle portion 238 are mating parts, with the step 230 slightly larger than the base flange 232. An installer can use force to push the saddle portion 238 into the recess 246 of the base portion 244, causing the elastic deformation of the base flange 232 and the step 230, which generates friction that holds the parts together and prevents relative movement, as illustrated in FIG. 3D.

The first spacer 200 may include a guide 274 within the recess 246 of the second stacking connector 204. The guide 274 in this aspect is a flange defining a tip 276, which is configured to center the first spacer 200 on the second spacer 302. An example guide 274 is illustrated in FIG. 2C. The guide 274 configured for mating engagement with a complementary structure on the second spacer. For example, the guide 274 may be configured for receipt into a saddle 372 of the aerial support tie 302 and/or a saddle 262 of another spacer.

The spacer 200 further includes a base portion 244 that includes the second stacking connector 204 and a saddle portion 238 that includes the first stacking connector 202. The saddle portion 238 is spaced apart from the base portion 244 and configured to optionally receive the second object 392. In aspects, the saddle portion 238 defines a saddle 240 that is configured to receive an object. The saddle portion may include a mount surface with an upwardly curved portion (about a longitudinal axis) that forms the saddle to support the object (e.g., a cable). For example, in FIG. 3B, the uppermost spacer 370 includes a saddle 372 (e.g., saddle 262) that is configured to receive object 392 (illustrated in FIGS. 3B and 3C).

The spacer 200 may include at least one wing (e.g., wing 282, wing 284, wing 286, wing 288) that extends from the base portion 244. The wing is configured to facilitate a manipulation of the spacer 200 by a technician, for example, by facilitating grasping the spacer 200 between a finger and a thumb of a technician installing the spacer 200. In aspects, the base portion 244 includes a grip section 278 includes at least one finger grip feature (grip feature 280, grip feature 280′) that projects outwardly from the grip section 278. The finger grip feature is configured to facilitate the manipulation of the spacer 200 by a technician, for example, by facilitating grasping the spacer 200 between a finger and a thumb of a technician installing the spacer 200. In aspects, the finger grip feature has a wavy texture.

FIGS. 3A-3D illustrate an aerial support tie system 300 that includes at least one aerial support tie spacer (e.g., spacer 200) and an aerial support tie (e.g., aerial support tie 302). The aerial support tie 302 includes a spacer portion configured to space a first object from a second object. In this way, the aerial support tie 302 can be referred to as second spacer 302. In aspects of an aerial support tie system, the aerial support tie may be omitted. The system 300 illustrated in FIGS. 3A-3D includes three aerial support tie spacers, namely, spacer 200 (the “first” spacer 200), a third spacer 350, and fourth spacer 370. The third spacer 350 and/or the fourth spacer 370 may be identical to the first spacer 200 and in this way, the third spacer 350 and/or the fourth spacer 370 may include one or more of the features of the spacer 200 described herein (e.g., stacking connector, recess, open channel, interlock portion, strap passageway, locking tab, and the like). In aspects, a system may include more or fewer spacers than the aspect of system 300.

The system 300 includes a stack of spacers, with the first spacer 200 stacked onto the second spacer 302 (e.g., aerial support tie 302), the third spacer 350 stacked onto the second spacer 302, and the fourth spacer 370 sacked onto the third spacer 350. The bottommost spacer (e.g., second spacer 302) is configured to attach to the first object 390 and the uppermost spacer (e.g., fourth spacer 370) is configured to attach to a second object 392. In this way, the first object 390 can be spaced apart from the second object 392 by the spacers of the system 300. In aspects, the first object 390 may be a covered conductor and the second object 392 may be a non-conducting messenger cable.

The first spacer 200 includes a first stacking connector 202 on a top side 266 of the first spacer 200 and a second stacking connector 204 on a bottom side 268 of the spacer. The first stacking connector 202 is configured to engage the second spacer 302 and the second stacking connector 204 is configured to engage the third spacer 350.

In FIGS. 3A-3D, the second spacer 302 includes a locking head 304 with a top side 306 that is configured as a stacking connector 308 that is configured to engage in a stacking relationship with the first stacking connector 202 of the spacer 200, as described below with respect to FIG. 3D. The first spacer 200 stacks onto the aerial support tie 302 by the second stacking connector 204 on a bottom side 268 of the spacer 200 engaging the top side 306 of the locking head 304. The locking head 304 may include a serration-engaging locking pawl mechanism that is configured for engaging strap serrations defined on the elongated strap 310, thereby retaining the strap relative to the locking head.

In the aspect illustrated in FIGS. 3A-3D, the system 300 includes a first spacer 200 (described above), a second spacer 302, a third spacer 350, and a fourth spacer 370. The first stacking connector 202 is configured to engage a stacking connector 308 of a second spacer 302 and the second stacking connector 204 is configured to engage a stacking connector of the third spacer 350, as illustrated in FIG. 3D. The first spacer 200 includes a strap passageway 252 and an open channel 248. The strap 310 can be laced through the strap passageway 252 to help align the spacer 200 to the top 306 of the aerial support tie 302. The open channel 248 is configured to allow easy wrapping of the strap 310 of the aerial support tie 302 around the second object 392 (e.g., guide wire) and back into the top of the locking head 304 of the aerial support tie 310. The third spacer 350 and the fourth spacer 370 also include a strap passageway and an open channel. When in the stacked configuration, as illustrated in FIGS. 3A-3D and FIG. 4, the strap passageways of the first, third, and fourth spacers align and the open channels of the first, third, and fourth spacers align.

In the aspect illustrated in FIGS. 3A-3D, the second spacer 302 is an aerial support tie that includes the elongated strap 310, a head 304 connectable to the elongated strap 310 to form a loop, and a stacking connector 308 that is configured to engage the second stacking connector 204 of the first spacer 200. The head 304 may be integrally joined the elongated strap 310.

The interlock portion 250 of the first spacer 200 is configured to lock the second stacking connector 204 to the third stacking connector 308, as illustrated in FIG. 3D. The interlock portion 250 includes a locking tab 270 that is configured to lock the first stacking connector 202 to the third stacking connector 308. The locking tab 270 includes at least one cantilever lug (272, 272′) that is configured for snap-fit connection with a connecting ledge (436, 438) of the second spacer 302, as illustrated in FIG. 3D. In this way, the first spacer 200 and the second spacer 302 are configured to connect.

FIGS. 3A and 3B illustrate an example installation procedure sequence. In FIG. 3A, the strap 310 of the aerial support tie 302 is wrapped around the first object 390 and back through the head 304 to form a first loop 312. During this operation, tension may be applied to hold the aerial support tie 302 (second spacer 302) in place on the first object 390. The other spacers (e.g., spacer 200, spacer 350, spacer 370) are then stacked together, and the free end of the strap 310 is then threaded through one or more of the spacers (e.g., through the strap passageways). The stack of spacers is then connected to the top of the second spacer 302, for example by snapping the bottommost spacer onto the top of the second spacer. In FIG. 3B, the free end of the strap 310 is then looped around the second object 392 (e.g., guy wire), passed through the open channel (e.g., open channel 248) of the spacers, inserted into the locking head 304 and into engagement with the serration-engaging locking pawl mechanism of the locking head to form a second loop 314. The strap 310 is pulled tight to a desired tension and any excess strap that protrudes from the spacer and/or head can then be cut off. In this way, the spacer and aerial support tie bundle the first object suspended and spaced apart from the second object. In further aspects, additional (or fewer) spacers may be stacked together with aligned strap passageways and open channels to further space the first object from the second object.

The parts of the disclosed aerial support tie spacers and/or the aerial support tie systems may be fabricated of any suitable material, including, but not limited to, a metal, a ceramic, a polymer (e.g., a polymeric material), and/or a composite. Suitable polymeric materials may include one or more of polyamide (PA), polypropylene (PP), polyethylene (PE), polyphenylene sulfide (PPS), polyether ether ketone (PEEK), polyaryletherketone (PAEK), ethylene tetrafluoroethylene (ETFE), polyacetal (POM), polybutylene terephthalate (PBT), ultraviolet stabilized polyacetal (POMUV), acrylonitrile styrene acrylate (ASA), cross-linked thermoplastics, partially cross-linked thermoplastics, higher-temperature resins, ultraviolet (UV) resistant resins, other thermoplastic materials, and the like, and copolymers, blends, or alloys thereof)) as well as fiber reinforced materials. A suitable polymeric material may include one or more additives (e.g., heat stabilizers (e.g., copper iodide), impact modifiers (e.g., polyolefin, urethane, rubber), UV stabilizers (e.g., carbon black, hindered amine light stabilizers (HALS)), flame retardants (e.g., nitrogen-based halogen-free flame retardants, melamine cyanurate, melamine borate, ammonium polyphosphate), colorants, and the like).

One or more of the parts of the disclosed aerial support tie spacers and/or the aerial support tie systems may be formed of the same material as the other parts, or of a different material than the other parts. One or more of the parts of an aerial support tie spacer may be integrally formed of a suitable material(s). The terms “integral” and “integrally formed” are used in this Detailed Description to describe elements that are formed in one piece (a single, unitary piece) and cannot be separably removed from each other without causing permanent structural damage to the piece. In implementations, one or more of the parts of the disclosed aerial support tie spacers can be assembled from separate plastic parts and fixed together through welding, solvents, adhesives, and the like.

One or more of the parts of the disclosed aerial support tie spacers and aerial support tie systems may be formed through a suitable fabrication technique. A suitable fabrication technique may include one or more of an injection-molding process, an additive manufacturing process (e.g., a fused deposition modeling (FDM) process, a fused deposition modeling (FDM) process, a three-dimensional (3D) printing process), or another suitable process.

Some additional examples of aerial support tie spacers and aerial support tie systems are described in the following Examples.
Example 1. A spacer configured to space a first object apart from a second object, the spacer comprising: a first stacking connector on a top side of the spacer, the first stacking connector configured to engage a second spacer; a second stacking connector on a bottom side of the spacer, the bottom side opposite the top side, the second stacking connector configured to engage a third spacer; a strap passageway defined in a first side of the spacer and extends from the top side to the bottom side, the strap passageway configured to receive an elongated strap therethrough in a first direction; and an open channel defined in a second side of the spacer and extends from the top side to the bottom side, the second side opposite the first side, the open channel configured to receive the elongated strap therein in a second direction, the second direction opposite the first direction.
Example 2. The spacer of Example 1, wherein the open channel comprises a first sidewall opposite and spaced apart from a second sidewall, the first and second sidewalls configured to guide the elongated strap in the second direction.
Example 3. The spacer of Example 2, wherein the first and second sidewalls are oriented substantially parallel to one another.
Example 4.The spacer of Example 3, wherein the first and second sidewalls are substantially parallel to the second direction.
Example 5. The spacer of Example 2, wherein an outer end of at least one of the first sidewall or the second sidewall includes a projection that extends into the open channel, the projection configured to retain the elongated strap within the open channel.
Example 6. The spacer of Example 1, wherein the spacer is a first spacer and the first spacer further comprises: an interlock portion configured to lock the second stacking connector to a stacking connector of a second spacer.
Example 7. The spacer of Example 6, wherein the interlock portion further comprises: a locking tab defined in at least one end of the spacer, the locking tab configured to lock the second stacking connector to the stacking connector of the second spacer.
Example 8. The spacer of Example 7, wherein the locking tab further comprises: at least one cantilever lug configured for snap-fit connection with a connecting ledge of the second spacer.
Example 9. The spacer of Example 6, wherein the second stacking connector further comprises: a recess configured to receive a portion of the second spacer.
Example 10. The spacer of Example 9, wherein the first spacer further comprises: a guide that extends into the recess, the guide configured to center the first spacer on the second spacer.
Example 11. The spacer of Example 6, wherein the first spacer is attachable to the second spacer by at least one of an interference fit or a snap fit.
Example 12. The spacer of Example 1, wherein the spacer further comprises: a base portion that includes the second stacking connector; and a saddle portion that includes the first stacking connector, the saddle portion spaced apart from the base portion and configured to receive the second object.
Example 13. The spacer of Example 12, wherein the saddle portion defines a saddle configured to receive the second object therein.
Example 14. The spacer of Example 12, wherein the spacer includes at least one wing that extends from the base portion, the wing configured to facilitate a manipulation of the spacer by a technician.
Example 15. The spacer of Example 12, wherein the base portion further comprises: a grip section configured to facilitate the manipulation of the spacer by a technician.
Example 16. A system configured to secure a first object and a second object, the system comprising: a first spacer configured to space the first object apart from the second object, the first spacer comprising: a first stacking connector on a top side of the first spacer, the first stacking connector configured to engage a stacking connector of a second spacer; a second stacking connector on a bottom side of the first spacer, the bottom side opposite the top side, the second stacking connector configured to engage a stacking connector of a third spacer; a strap passageway defined in a first side of the first spacer and extends from the top side to the bottom side, the strap passageway configured to receive an elongated strap of a cable tie therethrough in a first direction; and an open channel defined in a second side of the first spacer and extends from the top side to the bottom side, the top side opposite the bottom side, the open channel configured to receive the elongated strap therein in a second direction, the second direction opposite the first direction; and a second spacer comprising: an elongated strap; a head connectable to the elongated strap to form a loop; and a third stacking connector configured to engage the second stacking connector.
Example 17. The system of Example 16, wherein the first spacer further comprises: an interlock portion configured to lock the second stacking connector to the third stacking connector, the interlock portion includes a locking tab defined in at least one end of the first spacer and configured to lock at least one of the first stacking connector to the third stacking connector, the locking tab includes at least one cantilever lug configured for snap-fit connection with a connecting ledge of the second spacer.
Example 18. The system of Example 16, wherein the head is integrally joined the elongated strap.
Example 19. The system of Example 16, wherein the second stacking connector further comprises: a recess configured to receive a portion of the head.
Example 20. The system of Example 16, wherein the first spacer is attachable to the head by at least one of an interference fit or a snap fit.

In this document, the term “conductor” is used to include covered and uncovered single wires, bundles of wires, co-axial cables, and/or other elongate objects, including objects that do not conduct electricity. Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

In this description of aspects of aerial support tie spacers and aerial support tie spacer systems, ordinal numbers such as “first” and “second” are used only to distinguish between different described objects and have no limitation on a location, a sequence, a priority, a quantity, content, or the like of the described objects. For example, a “first end” is used as an example, and there may be one or more “ends.” Additionally, objects modified by different ordinal numbers may be the same or different objects. For example, if the described object is a “end,” a “first end” and a “second end” may be the same or different cradle arms.

In aspects, an aerial support tie spacer may include one or more of the features of an aerial support tie spacer illustrated in the Drawings and described herein. Although implementations of aerial support tie spacers and aerial support tie systems have been described in language specific to certain features and/or methods, the subject of the appended claims is not necessarily limited to the specific features or methods described. Rather, the specific features and methods are disclosed as example implementations of aerial support tie spacers and aerial support tie spacer systems.

What is claimed is:

1. A spacer configured to space a first object apart from a second object, the spacer comprising:
a first stacking connector on a top side of the spacer, the first stacking connector configured to engage a second spacer;
a second stacking connector on a bottom side of the spacer, the bottom side opposite the top side, the second stacking connector configured to engage a third spacer;
a strap passageway defined in a first side of the spacer and extends from the top side to the bottom side, the strap passageway configured to receive an elongated strap therethrough in a first direction (D1); and
an open channel defined in a second side of the spacer and extends from the top side to the bottom side, the second side opposite the first side, the open channel configured to receive the elongated strap therein in a second direction (D2), the second direction opposite the first direction.

2. The spacer of claim 1, wherein the open channel comprises a first sidewall opposite and spaced apart from a second sidewall, the first and second sidewalls configured to guide the elongated strap in the second direction.

3. The spacer of claim 2, wherein the first and second sidewalls are oriented substantially parallel to one another.

4. The spacer of claim 3, wherein the first and second sidewalls are substantially parallel to the second direction.

5. The spacer of claim 2, wherein an outer end of at least one of the first sidewall or the second sidewall includes a projection that extends into the open channel, the projection configured to retain the elongated strap within the open channel.

6. The spacer of claim 1, wherein the spacer is a first spacer and the first spacer further comprises:
an interlock portion configured to lock the second stacking connector to a stacking connector of a second spacer.

7. The spacer of claim 6, wherein the interlock portion further comprises:
a locking tab defined in at least one end of the spacer, the locking tab configured to lock the second stacking connector to the stacking connector of the second spacer.

8. The spacer of claim 7, wherein the locking tab further comprises:
at least one cantilever lug configured for snap-fit connection with a connecting ledge of the second spacer.

9. The spacer of claim 6, wherein the second stacking connector further comprises:
a recess configured to receive a portion of the second spacer.

10. The spacer of claim 9, wherein the first spacer further comprises:
a guide that extends into the recess, the guide configured to center the first spacer on the second spacer.

11. The spacer of claim 6, wherein the first spacer is attachable to the second spacer by at least one of an interference fit or a snap fit.

12. The spacer of claim 1, wherein the spacer further comprises:
a base portion that includes the second stacking connector; and
a saddle portion that includes the first stacking connector, the saddle portion spaced apart from the base portion and configured to receive the second object.

13. The spacer of claim 12, wherein the saddle portion defines a saddle configured to receive the second object therein.

14. The spacer of claim 12, wherein the spacer includes at least one wing that extends from the base portion, the wing configured to facilitate a manipulation of the spacer by a technician.

15. The spacer of claim 12, wherein the base portion further comprises:
a grip section configured to facilitate the manipulation of the spacer by a technician.

16. A system configured to secure a first object and a second object, the system comprising:
a first spacer configured to space the first object apart from the second object, the first spacer comprising:
a first stacking connector on a top side of the first spacer, the first stacking connector configured to engage a stacking connector of a second spacer;
a second stacking connector on a bottom side of the first spacer, the bottom side opposite the top side, the second stacking connector configured to engage a stacking connector of a third spacer;
a strap passageway defined in a first side of the first spacer and extends from the top side to the bottom side, the strap passageway configured to receive an elongated strap of a cable tie therethrough in a first direction (D1); and
an open channel defined in a second side of the first spacer and extends from the top side to the bottom side, the top side opposite the bottom side, the open channel configured to receive the elongated strap therein in a second direction (D2), the second direction opposite the first direction; and
a second spacer comprising:
an elongated strap;
a head connectable to the elongated strap to form a loop; and
a third stacking connector configured to engage the second stacking connector.

17. The system of claim 16, wherein the first spacer further comprises:
an interlock portion configured to lock the second stacking connector to the third stacking connector, the interlock portion includes a locking tab defined in at least one end of the first spacer and configured to lock at least one of the first stacking connector to the third stacking connector, the locking tab includes at least one cantilever lug configured for snap-fit connection with a connecting ledge of the second spacer.

18. The system of claim 16, wherein the head is integrally joined the elongated strap.

19. The system of claim 16, wherein the second stacking connector further comprises:
a recess configured to receive a portion of the head.

20. The system of claim 16, wherein the first spacer is attachable to the head by at least one of an interference fit or a snap fit.
